(19) United States
(12) Patent Application Publication
(10) Pub. No.: US 2010/0207895 A1
(43) Pub. Date: Aug. 19, 2010

(54) TACTILE INTERFACE DEVICE AND METHOD FOR CONTROLLING THE SAME

(75) Inventors: Il-Kweon Joung, Seongnam-si (KR); Kyungno Lee, Seoul (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/622,923

(22) Filed: Nov. 20, 2009

(30) Foreign Application Priority Data
Feb. 16, 2009 (KR) 10-2009-0013370
Feb. 24, 2009 (KR) 10-2009-0015243

(51) Int. Cl. G06F 3/041

(52) U.S. Cl. 345/173

(57) ABSTRACT

A tactile interface device and a method of controlling the same are disclosed. The tactile interface device can include a touchscreen, which has a slope formed in one surface, a driver, which vibrates the touchscreen in a horizontal direction such that the tactile feel at the surface of the touchscreen is changed, and a controller, which controls the operating frequency of the driver. The tactile interface device in accordance with an embodiment of the present invention can vibrate the touchscreen in a direction parallel to a surface of the touchscreen, providing the user with a sensation that the tactile feel changes at the portion that the user touches.

### CROSS-REFERENCE TO RELATED APPLICATIONS

This application claims the benefit of Korean Patent Application No. 10-2009-0013370, filed with the Korean Intellectual Property Office on Feb. 18, 2009, the disclosure of which is incorporated herein by reference in its entirety.

### BACKGROUND

1. Technical Field

The present invention relates to a tactile interface device and a method of controlling the same.

2. Description of the Related Art

A touchscreen is a type of input device that can transmit an input signal, which typically corresponds to a certain area pressed by a user's finger or by a stylus pen, to an electronic device equipped with the touchscreen.

However, when the user presses the certain area of the touchscreen, it is difficult for the user to know whether the input on the touchscreen has been made correctly or not, since the user has no feedback from the touchscreen.

To solve this problem, some of the new electronic devices equipped with a touch panel are equipped with vibrating motors. The vibrating motor may be activated to vibrate the device and provide the feedback to the user when the touch panel is touched. Nevertheless, the user still does not know whether or not the feedback is from the particular area pressed by the user, and the touchscreen device does not provide an appealing sensory feel.

### SUMMARY

The present invention provides a tactile interface device and a method of controlling the tactile interface device that can provide feedback in the form of a tactile feel in response to a user maneuvering a touchscreen.

An aspect of the present invention provides a tactile interface device that includes a touchscreen, in which one surface of the touchscreen has a slope; a driver, which vibrates the touchscreen in a horizontal direction such that a tactile feel of one surface of the touchscreen is changed; and a controller, which adjusts the operating frequency of the driver.

The operating frequency of the driver is 1 kHz or higher, and the operating frequency of the driver is above an audible frequency range. the driver includes a piezoelectric component.

There are a plurality of drivers, and the drivers are coupled to both sides of the touchscreen. The driver is coupled to one side of an edge of one surface of the touchscreen.

The tactile interface device further includes a protective panel coupled to one surface of the touchscreen. Here, the driver is coupled to one side of the protective panel such that a tactile feel of a surface of the protective panel is changed.

One surface of the touchscreen slopes from one end thereof towards the other end thereof, and one surface of the touchscreen slopes from both ends thereof towards a center line dividing the touchscreen. Also, one surface of the touchscreen curves convexly from both ends thereof towards a center line dividing the touchscreen.

One surface of the touchscreen curves concavely from both ends thereof towards a center line dividing the touchscreen, and one surface of the touchscreen is formed in a corrugated shape from one end thereof to the other end thereof. Also, one surface of the touchscreen curves concavely from an edge thereof towards a center thereof.

The controller controls the driver such that the driver vibrates the touchscreen at different frequencies depending on a pressed position of the touchscreen. Here, the controller is configured to partition a portion of the touchscreen as a virtual tactile area and to control the driver such that the driver vibrates the touchscreen at different frequencies depending on whether or not the pressed position of the touchscreen lies within the tactile area.

The tactile interface device further includes an image display panel coupled to the other surface of the touchscreen, and the driver is coupled to one side of the image display panel.

A plurality of icons are displayed on the image display panel, and the tactile area is formed between adjacent icons. An icon is displayed on the image display panel, and the tactile area is formed in an annular shape along an edge of the icon.

A scrollbar is displayed on the image display panel, and the tactile area is formed discontinuously along an extending direction of the scrollbar. If the scrollbar has an annular shape, the tactile area is formed in a radial shape on the scrollbar.

Another aspect of the present invention provides a method for controlling a tactile interface device that includes a touchscreen, a driver for vibrating the touchscreen in a direction parallel to one surface of the touchscreen, and an image display panel coupled to the other surface of the touchscreen. The method can include sensing whether or not the touchscreen is touched, and supplying a preset operating signal to the driver such that a tactile feel of one surface of the touchscreen is changed, if the touched position of the touchscreen is within a preset tactile area.

The method further includes, between the sensing of whether or not the touchscreen is touched and the supplying of the preset operating signal, defining the tactile area in accordance with an input mark, if the input mark is displayed on the image display panel.

If the input mark is an icon, the defining of the tactile area includes defining the tactile area in accordance with the icon. The defining of the tactile area includes defining the tactile area in accordance with a position and shape of the icon.

The defining of the tactile area includes defining the tactile area in an annular shape along an edge of the icon. If the input marks are a plurality of icons, the defining of the tactile area includes defining the tactile area between adjacent icons.

If the input mark is a scrollbar, the defining of the tactile area includes defining the tactile area in accordance with the scrollbar. The defining of the tactile area includes defining the tactile area discontinuously along an extending direction of the scrollbar. The defining of the tactile area includes defining the tactile area in a radial shape along the scrollbar having an annular shape.

The supplying of the operating signal includes supplying the operating signal having an operating frequency of 1 kHz or higher to the driver. The supplying of the operating signal includes supplying the operating signal having an operating frequency above an audible frequency range.

The supplying of the operating signal includes supplying a different operating signal to the driver depending on a type of the input mark. The operating signal is different in at least one of an amplitude, a frequency, and a duration depending on a type of the input mark.

The method further includes, after the supplying of the operating signal, measuring an elapsed time of supplying the operating signal. Here, if the elapsed time of supplying the operating signal exceeds a preset duration, the sensing of whether or not the touchscreen is touched is repeated.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view of a tactile interface device in accordance with a first disclosed embodiment of the present invention.

FIGS. 2 to 4 show how a tactile interface device can be operated in accordance with the first disclosed embodiment of the present invention.

FIGS. 5 to 9 are perspective views showing variations of a touchscreen that are applicable to a tactile interface device in accordance with the first disclosed embodiment of the present invention.

FIG. 10 is a flowchart showing a method of controlling a tactile interface device in accordance with the first disclosed embodiment of the present invention.

FIG. 11 is a plan view showing a first mode for a tactile interface device in accordance with the first disclosed embodiment of the present invention.

FIG. 12 is a graph showing operating signal patterns for a tactile interface device in accordance with the first disclosed embodiment of the present invention.

FIGS. 13 to 15 are plan views showing a second mode for a tactile interface device in accordance with the first disclosed embodiment of the present invention.

FIG. 16 is a plan view showing a third mode for a tactile interface device in accordance with the first disclosed embodiment of the present invention.

FIG. 17 is a plan view showing a fourth mode for a tactile interface device in accordance with the first disclosed embodiment of the present invention.

FIG. 18 is a plan view showing a fifth mode for a tactile interface device in accordance with the first disclosed embodiment of the present invention.

FIG. 19 is a perspective view showing a tactile interface device in accordance with a second disclosed embodiment of the present invention.

FIG. 20 is a perspective view showing a tactile interface device in accordance with a third disclosed embodiment of the present invention.

FIG. 21 is a perspective view showing a tactile interface device in accordance with a forth disclosed embodiment of the present invention.

FIG. 22 is a perspective view showing a tactile interface device in accordance with a fifth disclosed embodiment of the present invention.

FIG. 23 is a perspective view showing a tactile interface device in accordance with a sixth disclosed embodiment of the present invention.

### DETAILED DESCRIPTION

The features and advantages of this invention will become apparent through the below drawings and description. A tactile interface device, and method for controlling the tactile interface device, according to certain embodiments of the present invention will be described below in more detail with reference to the accompanying drawings. Those components that are the same or are in correspondence are rendered the same reference numeral regardless of the figure number, and redundant descriptions are omitted.

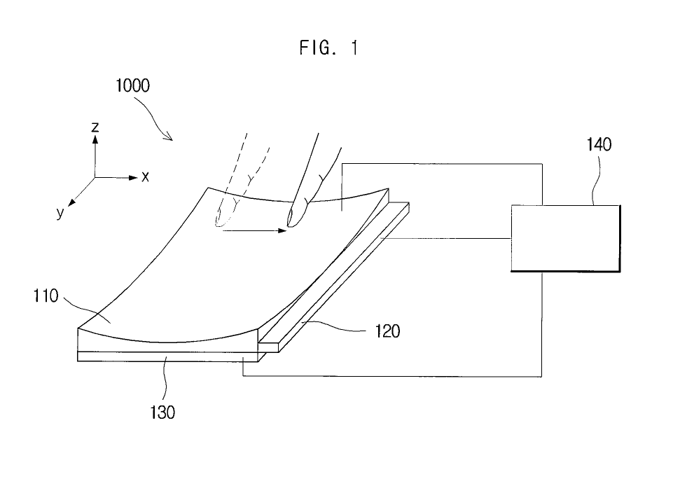

FIG. 1 is a perspective view of a tactile interface device 1000 in accordance with a first disclosed embodiment of the present invention. As in the example shown in FIG. 1, the tactile interface device 1000 in accordance with the first disclosed embodiment of the present invention can include a touchscreen 110, a driver 120, which vibrates the touchscreen 110 in a horizontal direction such that the tactile feel at the surface of the touchscreen 110 is changed, a controller 140, which controls the operating frequency of the driver 120, and an image display panel 130, which is coupled to the other surface of the touchscreen 110. Thus, the tactile interface device 1000 can provide a sensation that the tactile feel changes at the portion that the user touches.

The tactile interface device 1000 can be an input device, in which information can be inputted by a user's touch and a corresponding feedback can be supplied to the user in the form of a change in tactile feel at the portion that the user touches.

The tactile interface device 1000 can be employed as an input unit for a portable electronic device, such as a mobile phone 400, a personal digital assistant (PDA), a portable multimedia player (PMP) and an MPEG Audio Layer-3 (MP3) player, for example, as well as for other electronic devices, such as a navigator, a monitor, an automatic teller machine (ATM), a game console and an information kiosk. In such devices, the user may press a particular position on the touchscreen 110, at which the information related to the pressed position may be transferred to the controller 140.

Of course, if the tactile interface device 1000 also includes the image display panel 130, the tactile interface device 1000 can function as both an output and input unit for an electronic device to which the tactile interface device 1000 is applied.

The image display panel 130 may be coupled to a surface of the touchscreen 110. The image display panel 130, which is a part capable of displaying an image, such as an LCD panel, for example, can function as an output unit for the electronic device on which the tactile interface device 1000 is installed.

The image display panel 130 can be electrically connected with the controller 140, which will be described later in more detail, and can be made to display a variety of images by the controller 140 in accordance with the operational status of the electronic device to which the tactile interface device 1000 is installed. The image display panel 130 can display various items, such as an icon 410 and a scrollbar 415, for example, that allow the user to select menu choices.

The driver 120 can vibrate the touchscreen 110 in a horizontal direction such that the tactile feel at the surface of the touchscreen 110 is changed. That is, one surface of the touchscreen 110 can have a slope, while the other surface of the touchscreen 110 can be formed without a slope compared to the one surface. Here, the horizontal direction can be a direction parallel to the other surface of the touchscreen 110. In other words, one surface of the touchscreen 110 may have an angle other than an angle of 90 degrees with respect to the z-axis, and the moving direction of the touchscreen 110 can be along the x-axis or the y-axis.

The driver 120, which may use a piezoelectric component, for example, can be formed in the shape of a bar and coupled to one side of the touchscreen 110. The piezoelectric component can implement various forms of high-frequency vibrations depending on the direction of polarity. In the example shown in FIG. 1, the piezoelectric component can vibrate the touchscreen 110 in the direction of the x-axis.

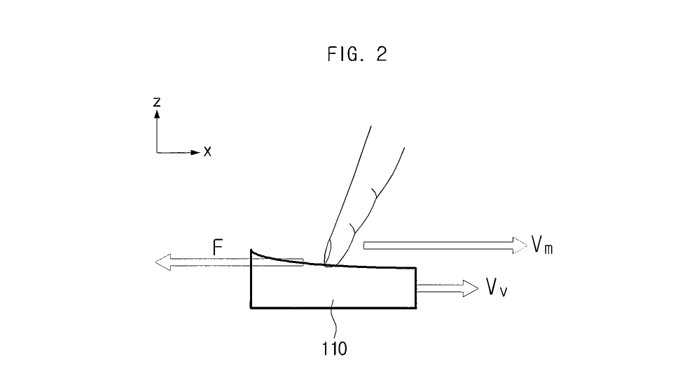

FIGS. 2 to 4 show how the tactile interface device 1000 can be operated in accordance with the first disclosed embodiment of the present invention. As illustrated in FIG. 2, if the user touches the touchscreen 110 and drags his or her finger on the touchscreen 110, a vibration on the touchscreen 110 that is applied at a speed (Vᵥ) slower than the speed (Vₘ) of the movement of the user's finger can cause the user to sense a friction (F) in the direction opposite to the movement of the finger, in addition to the texture of the surface of the touchscreen 110.

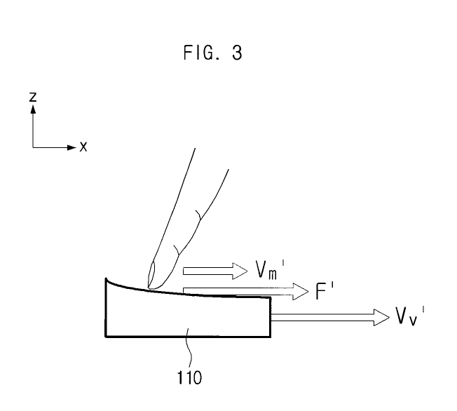

However, as illustrated in FIG. 3, if the touchscreen 110 vibrates at a speed (Vᵥ′) that is faster than the finger's moving speed (Vₘ′, the user can sense a friction (F′) in the same direction as the direction of movement of the user's finger. In other words, the user can receive a sensation that the friction has decreased at the surface of the touchscreen 110.

Numerous receptors exist in the human skin, each receptor transferring different information to the human brain according to the frequency range. Among these receptors, Pacinian corpuscles can sense vibrations within a frequency range of 10 to 500 Hz.

Therefore, by vibrating the touchscreen 110 at a frequency higher than 500 Hz, the driver 120 can provide sensory information that is perceived by the user not as a vibration, but as a change in tactile feel, caused by the reduction in friction at the surface of the touchscreen 110.

The range of frequencies perceived as vibrations can vary for each user. However, if the touchscreen 110 vibrates at a frequency of 1 kHz, for example, most users will perceive this as a change in tactile feel at the surface of the touchscreen 110.

Furthermore, if the frequency of the driver 120 is above the audible frequency range, i.e. above 20 kHz (for example, when a piezoelectric component is used, a frequency of up to 600 kHz may be obtained), the vibration of the touchscreen 110 may not be perceived by the user as noise. Thus, the user may perceive only the information provided in the form of a changed tactile feel on the surface of the touchscreen 110.

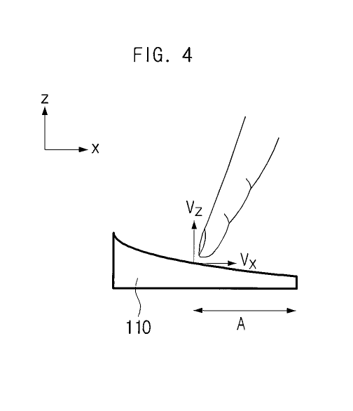

If one surface of the touchscreen 110 is formed concavely curved from the edge towards the center of the touchscreen 110, (i.e. one surface of the touchscreen 110 is formed with a slope), as illustrated in FIG. 4, the vibration of touchscreen 110 in the horizontal direction (direction A in FIG. 4) may provide relative speeds of Vₓ and V_{z} along the x-axis and the z-axis, respectively, for the touched position on the surface of the touchscreen 110, with respect to the user's finger.

The air between the one surface of the touchscreen 110 and the finger can be compressed due to the relative speed V_{z}. In particular, if the vibrating frequency of the one surface of the touchscreen 110 is 20 kHz or higher along the z-axis, the compressed air between the surface of the touchscreen 110 and the finger can reduce the friction between the surface of the touchscreen 110 and the finger, allowing the user to sense a change in tactile feel at the surface of the touchscreen 110. This is referred to as the “air squeeze effect.”

Therefore, because of the sloping surface of the touchscreen 110, relative movement can be implemented along the directions of the x-axis and the z-axis, between the surface of the touchscreen 110 and the finger. In this way, the reduction in friction due to the relative movement of the horizontal direction, as described earlier, as well as the reduction in friction due to the air squeeze effect can be provided at the same time. As a result, the user can better sense the change in tactile feel at the surface of the touchscreen 110.

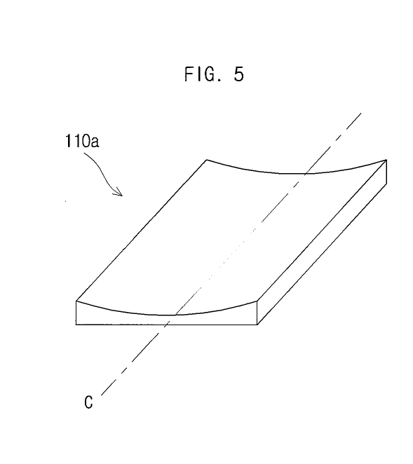

FIGS. 5 to 9 are perspective views showing variations of a touchscreen that are applicable to the tactile interface device 1000 in accordance with the first disclosed embodiment of the present invention. As illustrated in FIGS. 5 to 9, one surface of the touchscreen 110 may slope in a variety of forms.

First, as illustrated in FIG. 5, the touchscreen 110a can have a generally rectangular shape, and can be formed concavely curving from both ends towards a center line (C of FIG. 5) dividing the touchscreen 110a lengthwise. That is, the touchscreen 110a in FIG. 5 may be shaped symmetrically with respect to the center line (C of FIG. 5).

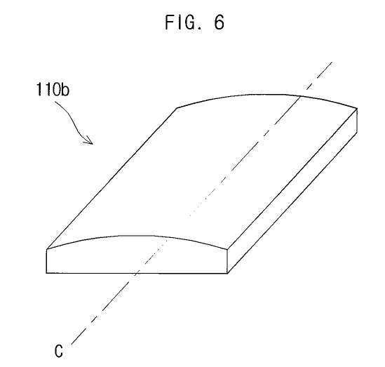

Next, as illustrated in FIG. 6, the touchscreen 110b can be formed convexly curving from both ends towards a center line (C of FIG. 6) dividing the touchscreen 110b. The touchscreen 110b can be formed with a smooth curve, protruding symmetrically with respect to the center line (C of FIG. 6).

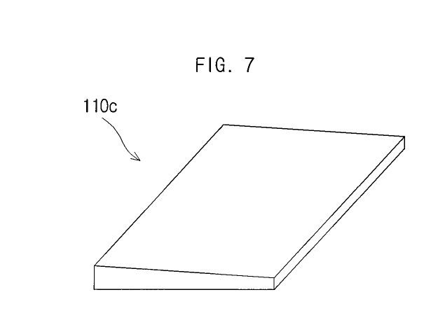

Next, as illustrated in FIG. 7, the one surface of the touchscreen 110c can be formed sloping from one end to the other. The touchscreen 110c may have a generally rectangular shape, with one side higher than the other, so that the surface of the touchscreen 110c slopes from one end to the other end.

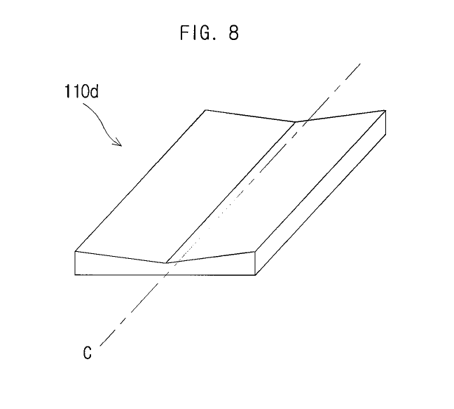

Next, as illustrated in FIG. 8, the surface of the touchscreen 110d can be formed sloping from both ends towards a center line (C of FIG. 8) dividing the touchscreen 110d. The height at both ends of the touchscreen 110d can be greater than that of the part where the center line (C of FIG. 8) passes, so that the surface of the touchscreen 110d can be formed sloping symmetrically from both ends of the touchscreen 110d towards the center line (C of FIG. 8).

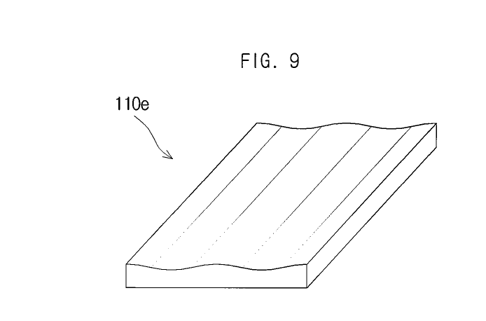

Next, as illustrated in FIG. 9, the surface of the touchscreen 110e can be formed in a corrugated shape from one end to the other. The touchscreen 110e can be formed with a convexly curving part and a concavely curving part repeating in an alternating manner, and this corrugated shape can be formed over the entire surface of the touchscreen 110e from one end to the other end.

The controller 140 can be electrically connected with the driver 120 and can control the operating frequency of the driver 120. The controller 140 can be electrically connected not only with the driver 120 but also with the touchscreen 110 and the image display panel 130, to control their operation.

The controller 140 can be implemented as a separate set of circuitry for controlling the operation of the tactile interface device 1000 or can be implemented as a part of the mechanism that controls the operation of the electronic device on which the tactile interface device 1000 is installed.

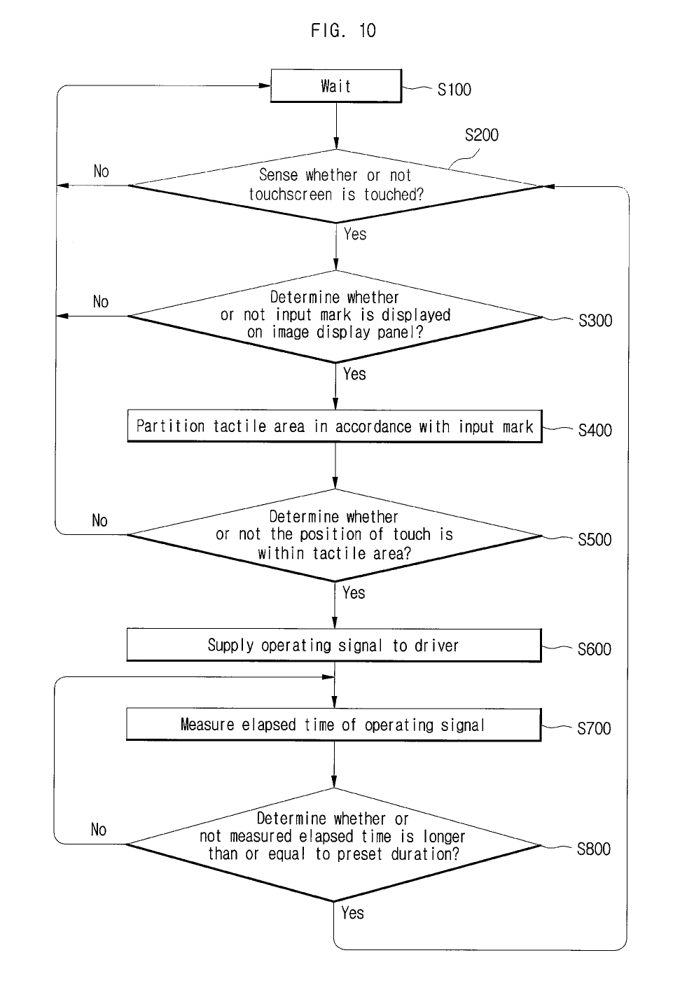

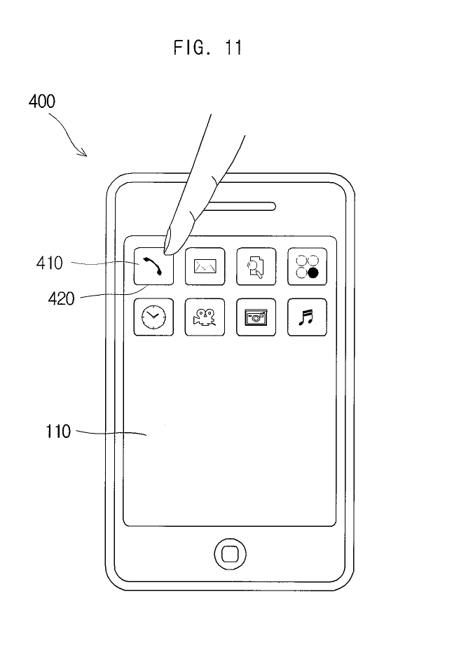

FIG. 10 is a flowchart showing a method of controlling the tactile interface device in accordance with the first disclosed embodiment of the present invention, and FIG. 11 is a plan view showing a first mode for the tactile interface device in accordance with the first disclosed embodiment of the present invention. As illustrated in FIG. 5, a control method of the tactile interface device 1000 in accordance with the first disclosed embodiment of the present invention will be described for an example in which the tactile interface device 1000 is applied to a mobile phone 400.

The tactile interface device 1000 can be applied to the mobile phone 400 to receive input from the user, output certain modes of the mobile phone 400 through the image display panel 130, and provide a varying tactile feel to the user by the vibration of the touchscreen 110.

In the initial standby state (S100), the touchscreen 110 may sense whether or not the touchscreen 110 is touched by the user (S200). Here, the touchscreen 110 may transmit information about the position of a touch to the controller 140. If there is no touch sensed by the touchscreen 110, the controller 140 may maintain the standby state (S100).

Next, the controller 140 may determine whether or not an input mark, such as an icon 410, is displayed on the image display panel 130 (S300), and if the icon 410 is displayed on the image display panel 130, may partition a portion of the touchscreen 110 as a tactile area 420 in accordance with the position and shape of the icon 410 (S400).

The input mark can be an item displayed on the image display panel 130 to receive input from the user and can be, for example, an icon 410 or a scrollbar 415.

The tactile area 420 can be a partitioned area on the touchscreen 110, and if the user touches a position within the tactile area 420, the tactile sensation of the touchscreen 110 can be changed by the operation of the driver 120, so that the user may be provided with a different tactile feel for the surface of the touchscreen 110 within the tactile area that is different from the tactile feel for the surface of the touchscreen 110 outside the tactile area 420.

The tactile area 420 can be configured in various forms in accordance with the type and shape of the input mark and, for example, can be formed on the touchscreen 110 to coincide with the positions and shapes of the icon 410, as illustrated in FIG. 5.

If there is no input mark such as an icon 410 displayed on the image display panel 130, the controller 140 may return to the standby state (S100) and wait for the user's touch.

The tactile area 420 can be preset by the user's manipulation or according to the designer's default settings, in which case the processes for determining whether or not the input mark is displayed on the image display panel 130 (S300) and setting the tactile area 420 in accordance with the input mark (S400) can be omitted.

In this case, the controller 140, after receiving information regarding the touched position from the touchscreen 110, can determine whether or not the position of the touch, which will be described later in more detail, is within the tactile area 420 in accordance with the preset tactile area 420 (S500).

Next, the controller 140, having received information regarding the pressing position from the touchscreen 110, may determine whether or not the touched position is within the tactile area 420 preset in the process described above (S500), and if the touched position is within the tactile area 420, an operating signal may be supplied to the driver 120 such that a tactile feel of one surface of the touchscreen is changed (S600).

The operating signal can be preset in accordance with the user's manipulation or the designer's settings and can be configured differently according to the type of input mark. For example, if there are different types of icons 410 displayed on the image display panel 130, a different operating signal can be supplied for each icon 410.

If there is a touch on the tactile area 420 formed for each of the icons 410, the controller 140 can supply a different preset operating signal accordingly.

For example, an icon 410 and a scrollbar 415 can be configured to provide different operating signals.

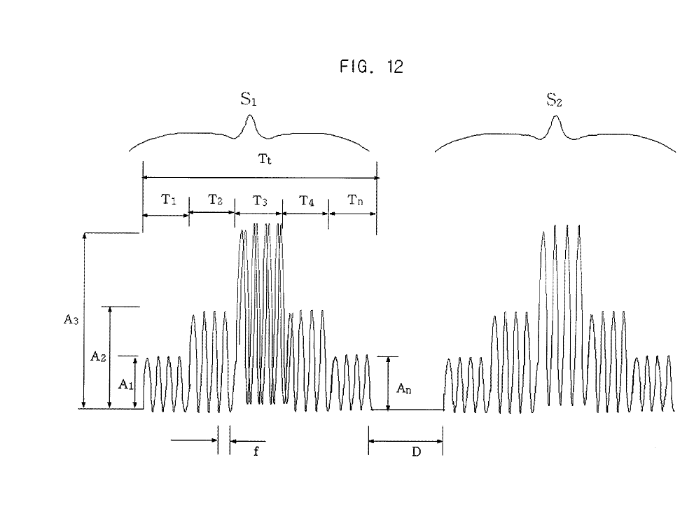

FIG. 12 is a graph showing operating signal patterns for a tactile interface device 1000 in accordance with the first disclosed embodiment of the present invention. As illustrated in FIG. 12, an operating signal can be defined by the amplitude (A), frequency (f) and elapsed time (Tₜ) of the signal's waveform (S). The operating signal can be changed to various forms by changing the any one of the amplitude (A), frequency (f) and elapsed time (Tt).

An operating signal can also be formed with the same waveform (S) repeated again and again. In this case, the operating signal can be distinguished from other signals not only by the amplitude, frequency and duration, but also by the interval (D) between the waveforms (S).

As such, the operating signal can have a variety of patterns, and the controller 140 can provide various tactile feels to the user by supplying the various preset operating signals to the driver 120.

If the pressing position by the user is not within the tactile area 420, the controller 140 may return to the standby state (S100). That is, if the user touches an area other than the tactile area 420 of the touchscreen 110, the user may not sense a change in tactile feel at the surface of the touchscreen 110, and thus the user can sense the position and shape of the icon 410, as illustrated in FIG. 5, not only by visual stimulus but also by the tactile sensation.

Next, after supplying the operating signal to the driver 120, the controller 140 may measure the elapsed time since supplying the operating signal (S700). Then, the controller 140 may determine whether or not the measured elapsed time is longer than or equal to the preset duration (S800), and if the preset duration of the operating signal has not elapsed, the controller 140 may continue to measure the elapsed time of the operating signal. If the elapsed time measured is longer than or equal to the preset duration, the process described earlier of sensing whether or not the touchscreen 110 is touched (S200) can be performed.

In other words, the user can be provided with a different tactile sensation within the tactile area 420 during the preset duration. Then, if the user's touch is not maintained after the duration, the tactile interface device 1000 may return to the standby state, whereas if the user's touch is maintained or there is a touch on another position, the user can be continuously provided with a different tactile sensation from the surface of the touchscreen 110, so that the tactile interface device 1000 may track the position of the user's touch and provide the user with different tactile feels.

The following descriptions will look at various ways in which the tactile area 420 may be arranged to provide the user with a difference in tactile feel. In the following description, a method of controlling the tactile interface device 1000 in accordance with the first disclosed embodiment of the present invention can be performed in accordance with the example shown FIG. 4 and thus will not be described again.

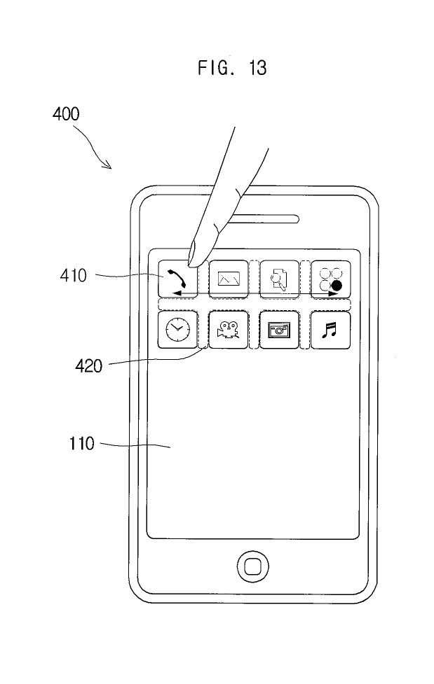

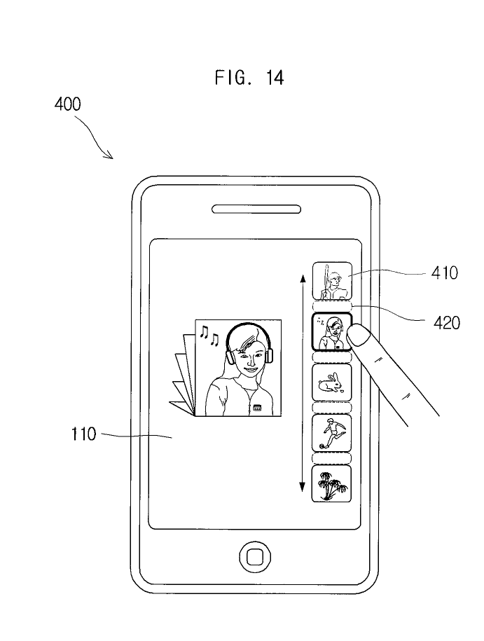

FIGS. 13 and 14 are plan views showing a second mode for a method of controlling the tactile interface device in accordance with the first disclosed embodiment of the present invention. As illustrated in FIG. 13, when the image display panel 130 displays a plurality of icons 140, the tactile area 420 can be formed between the plurality of icons 410, to separate the areas occupied by the icons 410 from other areas.

If the touched position lies outside the tactile area 420, the controller 140 can abstain from providing an operating signal to the driver 120, allowing the user to feel the natural texture of the surface of the touchscreen 110.

Therefore, if the user moves a finger over the plurality of icons 410, the portions between the plurality of icons 410 can provide the user with a different tactile sensation form the portions on which the plurality of icons 410 are displayed. As such, it will be felt by the user that the surface of touchscreen 110 is partitioned into virtual areas having different tactile feels.

As illustrated in FIG. 14, the image display panel 130 can display a photo saved in the mobile phone 400, with a plurality of icons 410 displayed on one side in a longitudinal direction that can be used to select other photos.

The plurality of icons 410 can be partitioned by tactile areas 420. If the touched position on the touchscreen 110 lies within a tactile area 420, the controller 140 can provide an operating signal to the driver 120, to provide the user with the sensation that the tactile feel of the surface of the touchscreen 110 has changed.

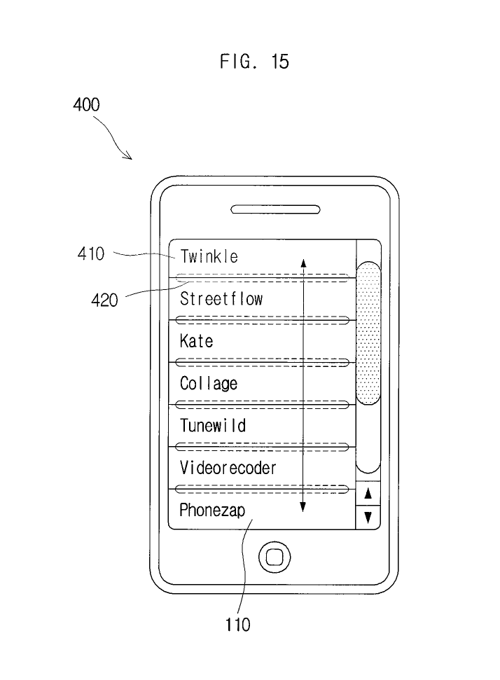

As illustrated in FIG. 15, the image display panel 130 can display laterally-extending icons 410 that are arranged in a longitudinal direction. In this case, the tactile areas 420 can be formed in the portions adjacent to the icons 410 along the lateral direction in which the icons 410 extend.

Thus, if the user moves upward or downward along the surface of the touchscreen 110, the user may sense different tactile feels for the areas displaying the icons 410 and the areas between icons 410, receiving a sensory feel that is generally congruous with the images displayed on the image display panel 130.

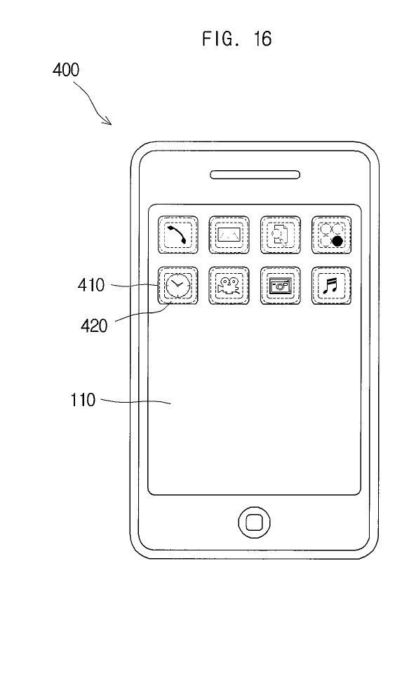

FIG. 16 is a plan view showing a third mode for a tactile interface device in accordance with the first disclosed embodiment of the present invention. As illustrated in FIG. 16, a plurality of icons 410 can be displayed on the image display panel, and a tactile area 420 can partition a portion of the touchscreen 110 in an annular shape along a perimeter of an icon 410.

If the touched position on the touchscreen 110 lies within a tactile area 420, the touchscreen 110 can vibrate, so that the user can perceive a different tactile feel at the boundaries of the icons 410. This enables the user to perceive the icons 410 through both visual and tactile sensations.

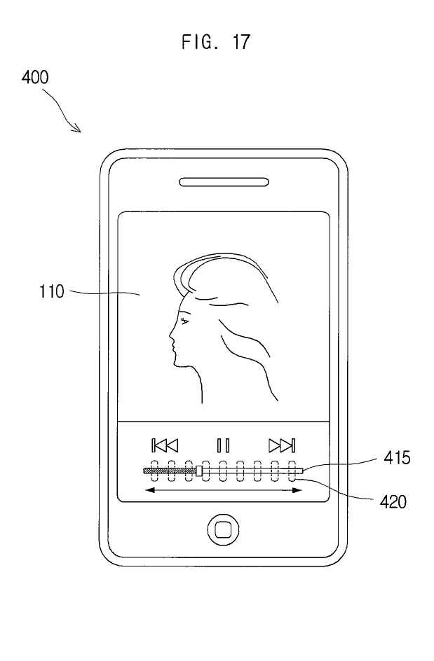

FIG. 17 is a plan view showing a fourth mode for a tactile interface device in accordance with the first disclosed embodiment of the present invention. In a mode for playing an audio file saved in the mobile phone 400, as illustrated in FIG. 17, the image display panel 130 can display a horizontal scrollbar 415 for adjusting the volume.

Here, the tactile areas 420 can be formed discontinuously in the same direction as the scrollbar 415. Each tactile area 420 can be arranged along the scrollbar 415 in certain intervals, to partition a portion of the touchscreen 110.

Thus, if the user moves along the scrollbar 415 to adjust the volume, the user can sense different tactile feels as the user's finger follows the scrollbar 415, receiving a sensation that the tactile feel is being changed.

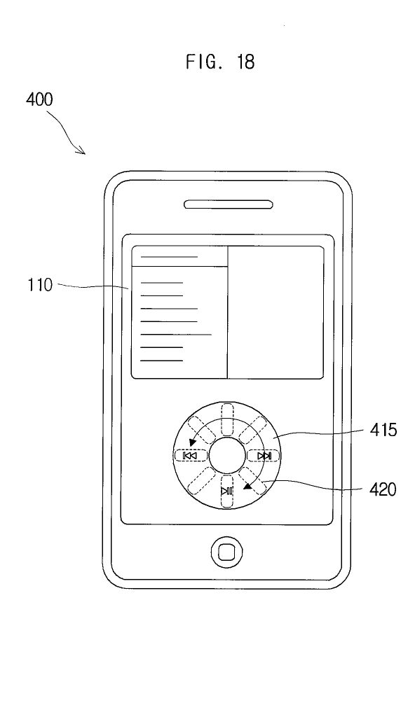

FIG. 18 is a plan view showing a fifth mode for a tactile interface device in accordance with the first disclosed embodiment of the present invention. As illustrated in FIG. 18, the image display panel 130 can on certain occasions display a scrollbar 415 having an annular shape, such as when saving an audio file recorded by the mobile phone 400.

On such occasions, the tactile areas 420 can be formed radially and discontinuously along the circular direction of the scrollbar 415 in certain intervals, on the touchscreen 110 on which the scrollbar 415 is displayed. Thus, the user can sense different tactile feels as the user's finger moves along the annular scrollbar 415, receiving a sensation that the tactile feel is being changed.

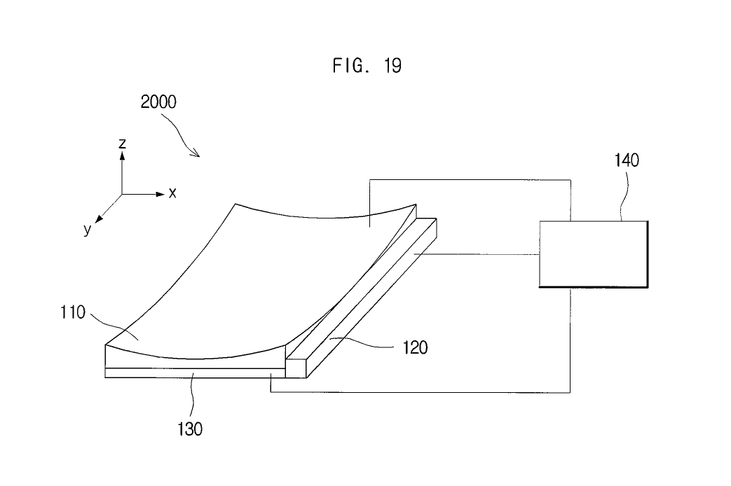

FIG. 19 is a perspective view showing a tactile interface device in accordance with a second disclosed embodiment of the present invention. As illustrated in FIG. 19, the tactile interface device 2000 in accordance with the second disclosed embodiment of the present invention can have the driver 120 coupled to one side of the touchscreen 110 and to the image display panel 130 as well.

As such, the touchscreen 110 and the image display panel 130 integrated with the driver 120 can be vibrated together in the direction of the x-axis. This can prevent losses in vibration that may otherwise occur as the driver 120 transfers the vibration to the touchscreen 110, so that sufficient vibration may be transferred to the touchscreen 110.

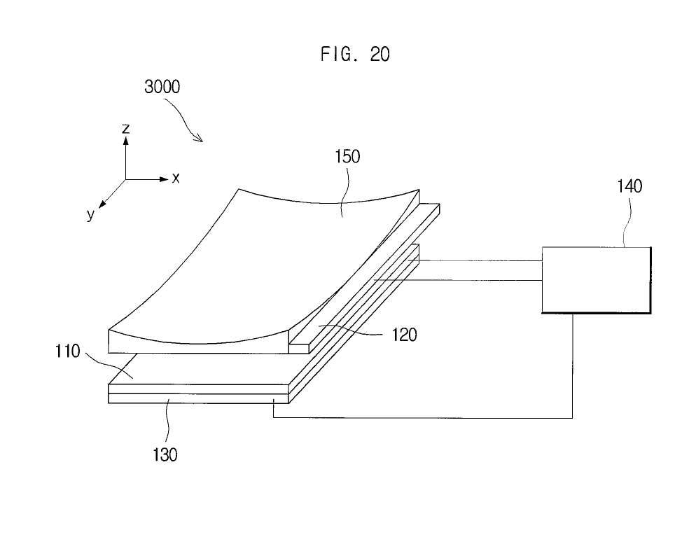

FIG. 20 is a perspective view showing a tactile interface device 3000 in accordance with a third disclosed embodiment of the present invention. As illustrated in FIG. 20, the tactile interface device 3000 in accordance with the third disclosed embodiment of the present invention can further include a protective panel 150 for protecting the touchscreen 110, coupled to one surface of the touchscreen 110.

The protective panel 150 can protect the surface of the touchscreen 110, and can be the portion that the user touches directly. Here, the driver 120 can be coupled to one side of the protective panel 150 to provide a vibration in the direction of the x-axis, whereby the change in tactile feel can be delivered directly to the user.

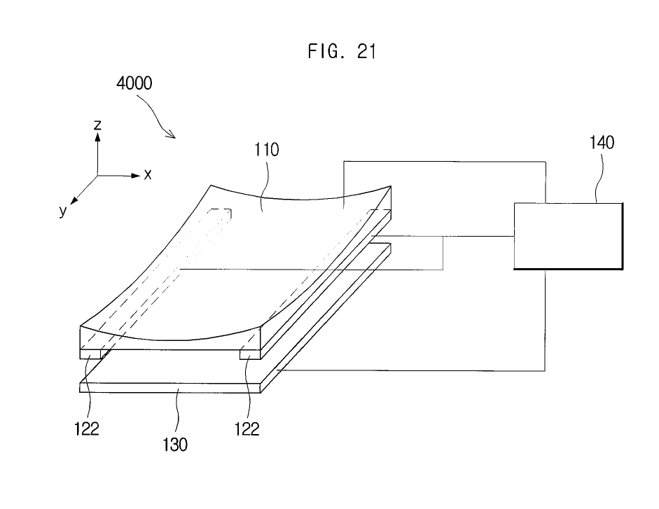

FIG. 21 is a perspective view showing a tactile interface device 4000 in accordance with a forth disclosed embodiment of the present invention. As illustrated in FIG. 21, the tactile interface device 4000 in accordance with the forth disclosed embodiment of the present invention can have a driver 122 coupled to one side on the edge of the touchscreen 110, as well as to the opposite side.

The driver 122 can be implemented with piezoelectric components, which may be polarized in such a way that allows vibration in the direction of the x-axis. In the present embodiment, the drivers 122 can be coupled to both sides of the touchscreen 110 to provide sufficient vibration to the touchscreen 110.

The drivers 122 can be coupled to portions other than the areas on which the images are displayed on the image display panel 130.

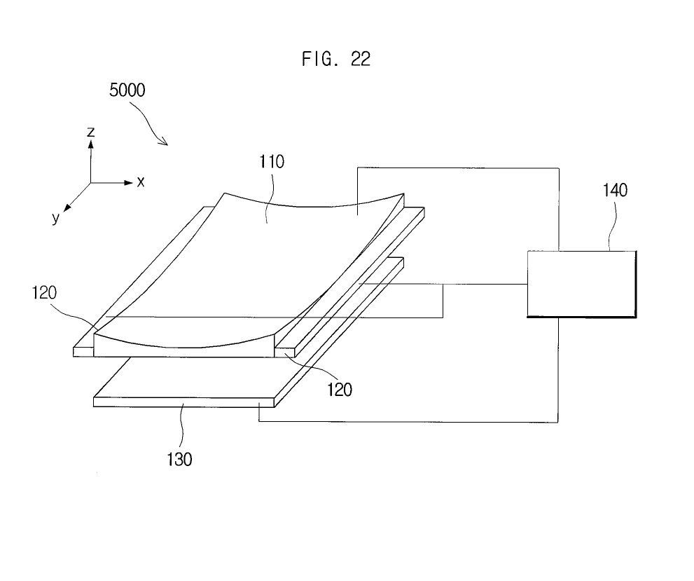

FIG. 22 is a perspective view showing a tactile interface device 5000 in accordance with a fifth disclosed embodiment of the present invention. As illustrated in FIG. 22, the tactile interface device 5000 in accordance with the fifth disclosed embodiment of the present invention can have the drivers 120 coupled to both sides of the touchscreen 110. Thus, the drivers 120 can provide sufficient vibration to the touchscreen 110 in the direction of the x-axis.

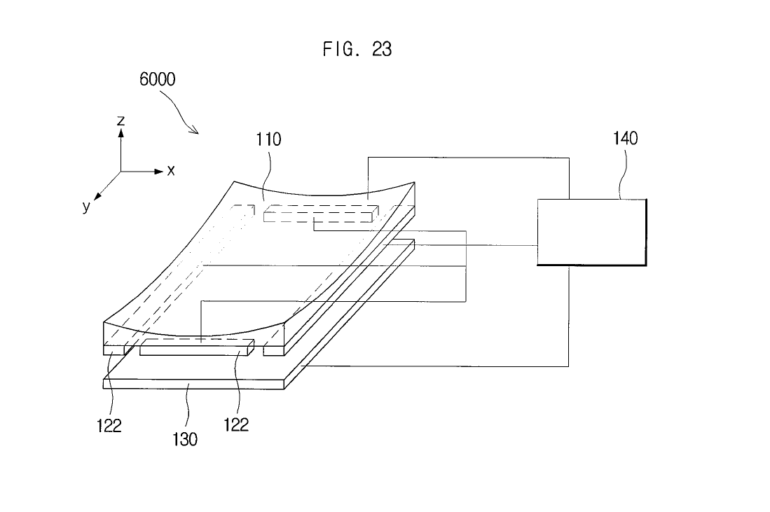

FIG. 23 is a perspective view showing a tactile interface device 6000 in accordance with a sixth disclosed embodiment of the present invention. As illustrated in FIG. 23, the tactile interface device 6000 in accordance with the sixth disclosed embodiment of the present invention can have the drivers 122 coupled to the edges of one surface of the touchscreen 110.

According to the direction of polarization of the piezoelectric components, i.e., the drivers 122, the touchscreen 110 can be made to vibrate in various directions, for example, along the x-axis and the y-axis. Therefore, by vibrating the touchscreen 110 in the direction of the x-axis when the user's finger moves along the surface of the touchscreen 110 in the x direction, and by vibrating the touchscreen 110 in the direction of the y-axis when the user's finger moves along the surface of the touchscreen 110 in the y direction, the same difference in tactile feel can be provided, regardless of the direction of the user's movement.

While the spirit of the invention has been described in detail with reference to particular embodiments, the embodiments are for illustrative purposes only and shall not limit the invention. It is to be appreciated that those skilled in the art can change or modify the embodiments without departing from the scope and spirit of the invention.

What is claimed is:

1. A tactile interface device comprising:
a touchscreen, one surface of the touchscreen having a slope;
a driver configured to vibrate the touchscreen in a horizontal direction, such that a tactile feel of one surface of the touchscreen is changed; and
a controller configured to adjust an operating frequency of the driver.

2. The tactile interface device of claim 1, wherein the operating frequency of the driver is 1 kHz or higher.

3. The tactile interface device of claim 2, wherein the operating frequency of the driver is above an audible frequency range.

4. The tactile interface device of claim 1, wherein the driver comprises a piezoelectric component.

5. The tactile interface device of claim 1, wherein there are a plurality of drivers.

6. The tactile interface device of claim 5, wherein the drivers are coupled to both sides of the touchscreen.

7. The tactile interface device of claim 1, wherein the driver is coupled to one side of an edge of one surface of the touchscreen.

8. The tactile interface device of claim 1, further comprising,
a protective panel coupled to one surface of the touchscreen,
wherein the driver is coupled to one side of the protective panel such that a tactile feel of a surface of the protective panel is changed.

9. The tactile interface device of claim 1, wherein one surface of the touchscreen slopes from one end thereof towards the other end thereof.

10. The tactile interface device of claim 1, wherein one surface of the touchscreen slopes from both ends thereof towards a center line dividing the touchscreen.

11. The tactile interface device of claim 1, wherein one surface of the touchscreen curves convexly from both ends thereof towards a center line dividing the touchscreen.

12. The tactile interface device of claim 1, wherein one surface of the touchscreen curves concavely from both ends thereof towards a center line dividing the touchscreen.

13. The tactile interface device of claim 1, wherein one surface of the touchscreen is formed in a corrugated shape from one end thereof to the other end thereof.

14. The tactile interface device of claim 1, wherein one surface of the touchscreen curves concavely from an edge thereof towards a center thereof.

15. The tactile interface device of claim 1, wherein the controller is configured to control the driver such that the driver vibrates the touchscreen at different frequencies depending on a pressed position of the touchscreen.

16. The tactile interface device of claim 15, wherein the controller is configured to partition a portion of the touchscreen as a virtual tactile area and to control the driver such that the driver vibrates the touchscreen at different frequencies depending on whether or not the pressed position of the touchscreen lies within the tactile area.

17. The tactile interface device of claim 16, further comprising
an image display panel coupled to the other surface of the touchscreen.

18. The tactile interface device of claim 17, wherein the driver is coupled to one side of the image display panel.

19. The tactile interface device of claim 17, wherein an icon is displayed on the image display panel, and
the tactile area is formed in accordance with a position and shape of the icon.

20. The tactile interface device of claim 17, wherein a plurality of icons are displayed on the image display panel, and
the tactile area is formed between adjacent icons.

21. The tactile interface device of claim 17, wherein an icon is displayed on the image display panel, and
the tactile area is formed in an annular shape along an edge of the icon.

22. The tactile interface device of claim 17, wherein a scrollbar is displayed on the image display panel, and
the tactile area is formed discontinuously along an extending direction of the scrollbar.

23. The tactile interface device of claim 22, wherein the scrollbar has an annular shape, and
the tactile area is formed in a radial shape on the scrollbar.

24. A method for controlling a tactile interface device comprising a touchscreen, a driver configured to vibrate the touchscreen in a direction parallel to one surface of the touchscreen, and an image display panel coupled to the other surface of the touchscreen, the method comprising:
sensing whether or not the touchscreen is touched; and
supplying a preset operating signal to the driver such that a tactile feel of one surface of the touchscreen is changed, if the touched position of the touchscreen is within a preset tactile area.

25. The method of claim 24, further comprising, between the sensing of whether or not the touchscreen is touched and the supplying of the preset operating signal:
defining the tactile area in accordance with an input mark, if the input mark is displayed on the image display panel.

26. The method of claim 25, wherein, if the input mark is an icon, the defining of the tactile area includes defining the tactile area in accordance with the icon.

27. The method of claim 26, wherein the defining of the tactile area includes defining the tactile area in accordance with a position and shape of the icon.

28. The method of claim 26, wherein the defining of the tactile area includes defining the tactile area in an annular shape along an edge of the icon.

29. The method of claim 26, wherein, if the input marks are a plurality of icons, the defining of the tactile area includes defining the tactile area between adjacent icons.

30. The method of claim 25, wherein, if the input mark is a scrollbar, the defining of the tactile area includes defining the tactile area in accordance with the scrollbar.

31. The method of claim 30, wherein the defining of the tactile area includes defining the tactile area discontinuously along an extending direction of the scrollbar.

32. The method of claim 31, wherein the defining of the tactile area includes defining the tactile area in a radial shape along the scrollbar having an annular shape.

33. The method of claim 24, wherein the supplying of the operating signal includes supplying the operating signal having an operating frequency of 1 kHz or higher to the driver.

34. The method of claim 33, wherein the supplying of the operating signal includes supplying the operating signal having an operating frequency above an audible frequency range.

35. The method of claim 24, wherein the supplying of the operating signal includes supplying a different operating signal to the driver depending on a type of the input mark.

36. The method of claim 35, wherein the operating signal is different in at least one of an amplitude, a frequency, and a duration depending on a type of the input mark.

37. The method of claim 24, further comprising, after the supplying of the operating signal:
measuring an elapsed time of supplying the operating signal,
wherein, if the elapsed time of supplying the operating signal exceeds a preset duration, the sensing of whether or not the touchscreen is touched is repeated.
